(19) United States
(12) Patent Application Publication
(10) Pub. No.: US 2006/0250657 A1
(43) Pub. Date: Nov. 9, 2006

(54) Method for operating a laser engraver

(75) Inventor: Jin-Sheng Lai, Hsi Chih City (TW)

Correspondence Address: LOWE HAUPTMAN BERNER, LLP, 1700 DIAGONAL ROAD, SUITE 300, ALEXANDRIA, VA, 22314, US

(73) Assignee: Great Computer Corporation

(21) Appl. No.: 11/121,029

(22) Filed: May 4, 2005

(51) Int. Cl. B41C 1/04

(52) U.S. Cl. 358/3.29

(57) ABSTRACT

A method for operating a laser engraver is to input parameters in a computer and the parameters being set to the laser engraver. The laser engraver proceeds a function of auto-focus or off-focus according the parameters so that the laser engraver is automatically focused while cutting an object. The parameters includes functions of auto-focus on different planes such that the laser engraver automatically focuses regarding different planes without stopping the engraver. This saves time and is convenient for the users to operate the laser engraver.

### FIELD OF THE INVENTION

The present invention relates to a method for operating a laser engraver, and more particularly, to a method with a function of automatically focusing so that the engraver is able to work on different surfaces.

### BACKGROUND OF THE INVENTION

Laser is used in different areas such as measuring, analyzing, data storing and communication. Laser is also used for engraving a highly precision product and a laser engraver transfer electric power into optical energy to cut an object. The laser beam is focused at the surface of the object and the optical energy is absorbed by the material of the object and the affected area of the object is vaporized so as to achieve the purpose of cutting and engraving.

The laser system for a laser engraver includes a control panel, CPU, DC power supply, laser tube and operation system.

Generally, the user operates the control panel which includes a touch panel and LCD display screen to operate the laser tube. Commands are input to the laser engraver by using a computer, the laser engraver generates a laser beam and the operation system is activated. The laser tube having plasmatrons of carbon dioxide or other gases and Radio Frequency transfers the electric power into optical energy. The whole system is operated by the mechanical operation including rails, electric motors, bearings, belts, lenses and other necessary parts.

As shown in FIG. 1, a conventional laser engraver is operated according to the following six steps A10 to A60. The user sets parameters in the computer and the parameters are sent to the laser engraver (A10), the cutting point is moved above the object to be engraved (A20), the Auto-Focus button is pushed to focus (A30), the laser engraver proceeds focusing by moving Z-axis platform (A40), the user pushes Start/Stop button to start or stop the laser engraver (A50), and the laser engraver begins to work (A60). It is noted that the user has to push the Auto-Focus button to automatically focus the laser beam at the desired surface. Nevertheless, the procedure is often omitted or forgotten by the user because of unintentional reasons and the whole cutting or engraving procedure is therefore delayed.

Besides, the conventional laser engraver can only work on a plane by using the Auto-Focus button. If the laser engraver works on different planes, the Auto-Focus button has to be pushed again when the cutting point is moved to another plane. This operation is not automatic, and the engraving procedure will be effected.

### SUMMARY OF THE INVENTION

The main objective of the present invention is to provide a method for operating a laser engraver, wherein the function parameters including auto-focus is set in a computer and the laser engraver proceeds the set functions including the function of auto-focus to cut an object.

Another objective of the present invention is to provide a method for operating a laser engraver, wherein the auto-focus parameters of different planes on the object to be machined are input in the computer. The laser engraver cuts the object with different planes by the pre-set parameters and the auto-focus functions are operated when machining on different planes. By this way, the time of work is saved.

A further objective of the present invention is to provide a method for operating a laser engraver, wherein different focus parameters on the same plane is set and off-focus parameters are produced so that the laser engraver is able to cut a precise product.

In order to achieve the above-mentioned objectives, the method includes the following steps which are:

Step 1: inputting parameters in a computer and the parameters being set to a laser engraver;

Step 2: pushing Start button on the laser engraver;

Step 3: the laser engraver proceeding a function of auto-focus or off-focus according the parameters;

Step 4: moving a cutting point above an object when the laser engraver proceeds the function of auto-focus;

Step 5: moving the z-axis platform according to the parameters to focus, and

Step 6: the laser engraver starting to work.

When the laser engraver is set not to proceed the function of auto-focus in step 3, the step 6 is proceeded.

During step 1, the parameters can be set to auto-focus on different planes, or to have different focuses on the same plane.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows conventional steps of the method for operating a laser engraver;

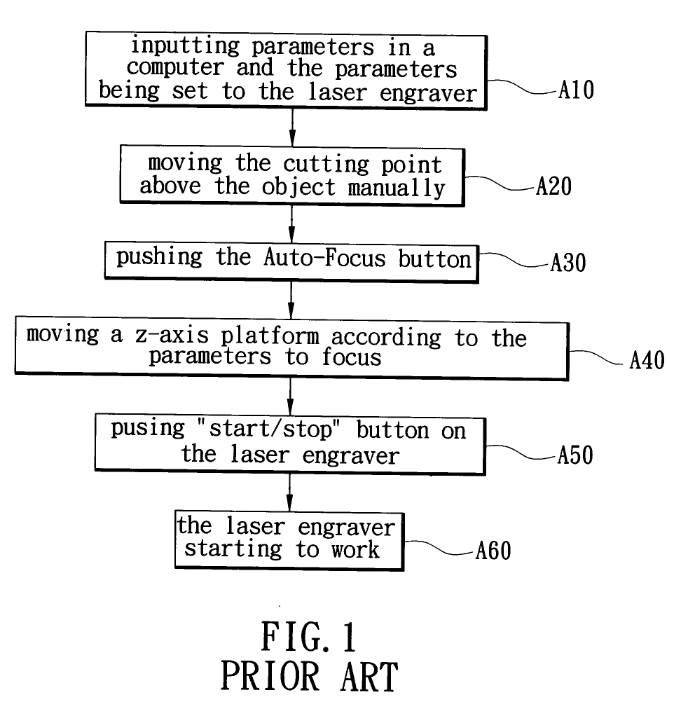

FIG. 2 shows steps of the method of the present invention for operating a laser engraver;

FIG. 3 shows steps of another method of the present invention for operating a laser engraver, and

FIG. 4 shows steps of yet another method of the present invention for operating a laser engraver.

### DETAILED DESCRIPTION OF THE PREFERRED EMBODIMENT

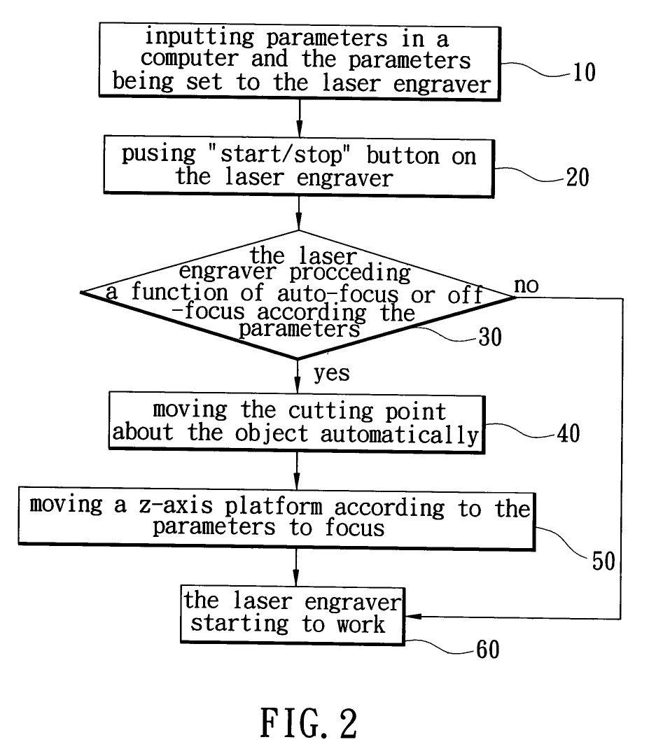

Referring to FIG. 2, the method for operating a laser engraver of the present invention comprises the following steps which are:

step 1 (10): inputting parameters in a computer and the parameters being set to the laser engraver;

The parameters includes parameters of auto-focus and off-focus. These parameters are input by operation on the control panel by the user.

step 2 (20): pushing Start button on the laser engraver;

step 3 (30): the laser engraver proceeding a function of auto-focus according the parameters;

The laser engraver starts to work according to the commands of parameters after the user pushes the Start button. If the parameter input commands the laser engraver to proceed auto-focus, the step 4 (40) is proceeded.

step 4 (40): moving a cutting point of the laser engraver above an object when the laser engraver proceeds the function of auto-focus;

step 5 (50): moving a z-axis platform according to the parameters to focus;

After the function of auto-focus is completed, the laser engraver starts to work as set in step 6 (60).

step 6 (60): the laser engraver starting to work.

If the parameter input the laser engraver is set not to proceed the function of auto-focus in step 3, the steps 4 and 5 are omitted and the step 6 is proceeded directly.

The user can pre-set the function to auto-focus or off-focus so that the user needs not to push the auto-focus button when the function of auto-focus is needed as described in the conventional method.

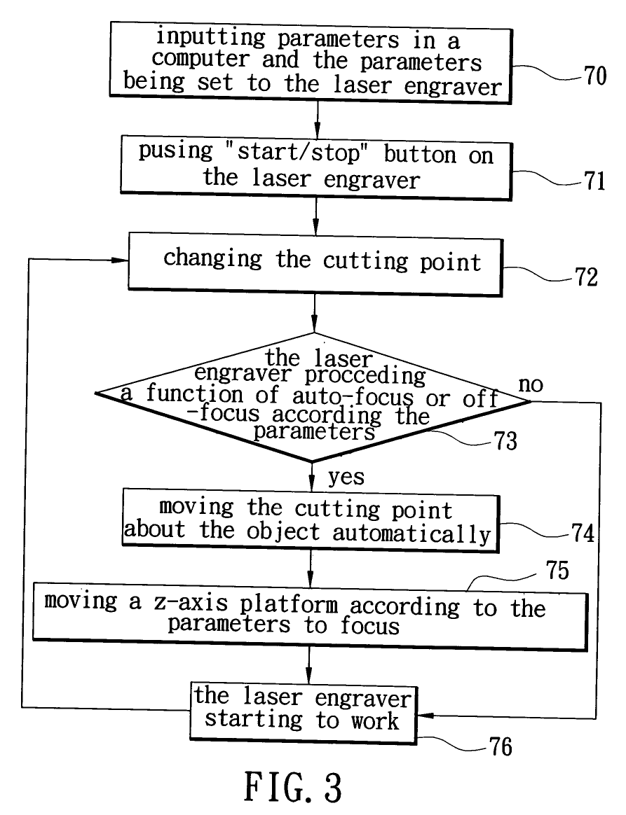

As shown in FIG. 3, in order to eliminate the procedures of pushing the auto-focus button when cutting a different plane, the parameters in step 1 includes parameters of focusing different planes. The steps is disclosed as follows:

step 1 (70): inputting the individual parameters of the focusing on different planes in the computer and sending the parameters to the laser engraver;

step 2 (71): pushing Start button on the laser engraver;

step 3 (72): changing the cutting points:

step 4 (73): the laser engraver proceeding a function of auto-focus or off-focus according the parameters;

step 5 (74): moving a cutting point of the laser engraver above an object when the laser engraver proceeds the function of auto-focus;

step 6 (75): moving a z-axis platform according to the parameters to focus;

step 7 (76): the laser engraver starting to work.

If the parameter requires the laser engraver to proceed the function of auto-focus, the cutting point moves to the object and the z-axis platform is moved to focus. After the focus is completed, the laser engraver starts to work.

If the parameter input the laser engraver is set not to proceed the function of auto-focus, the steps 4 and 5 are omitted and the step 6 is proceeded directly and the user controls the cutting procedures of cutting.

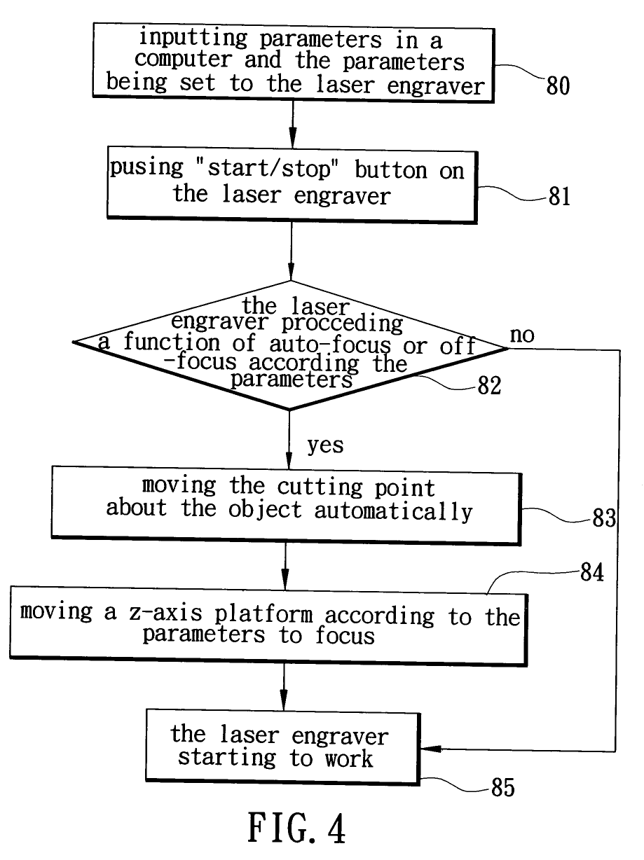

As shown in FIG. 4, the parameters may include parameters of change of focus, and the method includes the followings:

step 1 (80): inputting the individual parameters of the focusing on different planes in the computer and sending the parameters to the laser engraver;

step 2 (81): pushing Start button on the laser engraver;

step 3 (82): the laser engraver proceeding a function of auto-focus or off-focus according the parameters;

step 5 (83): moving a cutting point of the laser engraver above an object when the laser engraver proceeds the function of auto-focus;

step 6 (84): moving a z-axis platform according to the parameters to focus, and

step 7 (85): the laser engraver starting to work.

If the parameter commands the laser engraver to first proceed auto-focus and then second to proceed off-focus, the z-axis platform moves to focus first and then to off-focus. By this way, the object can be machined precisely.

If the parameter input the laser engraver is set not to proceed the function of auto-focus, the user controls the cutting procedures of cutting.

The method includes the following advantages:

1. The parameters are input into a computer and then sent to the laser engraver which is moved according to the pre-set parameters so that the steps of operation of the laser engraver are simplified.

2. The input parameters can be different focus parameters which are used to different planes so that the laser engraver needs not to be stopped when machining an object with different planes and the laser engraver automatically focuses on each individual plane.

3. The parameters can further includes function of off-focus after completion of the auto-focus so as to have a final product with better quality.

While we have shown and described the embodiment in accordance with the present invention, it should be clear to those skilled in the art that further embodiments may be made without departing from the scope of the present invention.

What is claimed is:

1. A method for operating a laser engraver comprising the following steps:
step 1: inputting parameters in a computer and the parameters being set to the laser engraver;
step 2: pushing Start button on the laser engraver;
step 3: the laser engraver proceeding a function of auto-focus or off-focus according the parameters;
step 4: moving a cutting point of the laser engraver above an object when the laser engraver proceeds the function of auto-focus;
step 5: moving a z-axis platform according to the parameters to focus, and
step 6: the laser engraver starting to work.
when the laser engraver is set not to proceed the function of auto-focus in step 3, the step 6 is proceeded.

2. The method as claimed in claim 1, wherein the parameters in step 1 includes parameters of focusing different planes.

3. The method as claimed in claim 1, wherein a step of changing the cutting point is added between step 2 and step 3, so that the cutting point is changed for proceeding focusing on different planes.

4. The method as claimed in claim 1, wherein the parameters in step 1 includes parameters of off-focus on one plane.

5. The method as claimed in claim 4 further comprising actions of off-focus by moving the z-axis platform according the parameter in step 5.
